(19) United States
(12) Patent Application Publication
(10) Pub. No.: US 2015/0316179 A1
(43) Pub. Date: Nov. 5, 2015

(54) COMPOSITE TUBULAR STRUCTURES

(71) Applicant: Charles Dwight Jarvis, Jonesboro, GA (US)

(72) Inventor: Charles Dwight Jarvis, Jonesboro, GA (US)

(21) Appl. No.: 14/269,091

(22) Filed: May 3, 2014

(51) Int. Cl. F16L 9/18; F16L 9/14

(52) U.S. Cl. CPC F16L 9/18; F16L 9/14

(57) ABSTRACT

Various implementations of composite tubular structures are disclosed. The composite tubular structures of the present disclosure may have improved formability, increased strength, reduced weight, or a combination of the foregoing. Furthermore, the composites tubular structures of the present disclosure may have greater strength to weight ratios than prior art composites.

### TECHNICAL FIELD

This disclosure relates to composite tubular structures.

### BACKGROUND

The geometrical construction of a structure may be an important factor in its performance. For example, it has been long known that triangles are very useful in producing stronger structures.

### BRIEF DESCRIPTION OF DRAWINGS

FIGS. 1A1-1D4 illustrate the impact of the geometry of a tubular structure on the axial and torsional strength of the tubular structure.

FIG. 2 illustrates a prior art crossbeam constructed from thin-walled round steel tubing inserted into square steel tubing that is glued and spot-welded together.

FIGS. 3A through 3C illustrate the basic principle of using multiple triangles to further reinforce rectangular tubing composites.

FIGS. 4A through 4C illustrate the same for round tubing composites.

FIGS. 5A through 5D illustrate the insertion of additional, various extrusions that improve the axial strength of round tubing composites.

FIGS. 6A and 6B illustrate the use of internal arrays to increase the resistance of rectangular tubing to torsional and axial failures.

FIGS. 7A through 7I illustrate how tubular extrusions with interlocking shapes further strengthen tubular composites.

FIGS. 8A through 8C illustrate the use of geometry to weaken a tubular structure in one axis relative to the perpendicular one in order to increase formability in the weaker direction.

FIGS. 9A through 9C illustrate the use of metallic meshes to modify the thermal coefficient of expansion and thermal conductivity of the adhesive to increase the resistance of the adhesive bond to pealing during the daily heat cycle.

FIGS. 10A and 10B illustrate example implementations of round tubular composites as a handle for a hand tool and as a light weight drive shaft.

### DETAILED DESCRIPTION

Various implementations of composite tubular structures are disclosed. The composite tubular structures of the present disclosure may have improved formability, increased strength, reduced weight, or a combination of the foregoing. Furthermore, the composites tubular structures of the present disclosure may have greater strength to weight ratios than prior art composites.

In some implementations, the thickness of the tubes, the material from which the tubes are made and the tubes geometries are selected to meet specified strength to weight ratio requirements and/or to meet specific formability requirements.

In some implementations, composite tubular structures are formed by inserting a first tube into a second tube, forming the tubes as needed, and joining the tubes together by, for example, curing previously deposited adhesive or brazing. In some implementations, the tubes are joined by welding. In some implementations, the first, inner tube is dimensioned so that there is physical contact between at least a portion of an outer surface of the inner tube, bonding material, (for example adhesive), and at least a portion of an inner surface of the second, outer tube. For composite structures joined by adhesives, the relative dimensions of the inner and outer tubes may be specified to control the thickness of the adhesive bond to maximize the strength of the bond.

In some implementations, a composite tubular structure is formed by inserting an inner square tube diagonally into an outer square tube. In some implementations, the inner square tube is dimensioned such that all four corners of the inner square tube can be joined to the interior surface of the outer square tube. In some implementations, the interior surface of the outer square tube includes notches and the inner square tube is configured such that the corners of the inner square tube can mate with and be joined with the notches on the interior sides of the outer tube.

In some implementations, a composite tubular structure is formed by inserting a hexagon shaped tube into a square tube. In some implementations, the hexagon tube is dimensioned such that all six corners of the hexagon tube can be joined to the interior surface of the square tube. In some implementations, the hexagon tube is dimensioned such that a pair of parallel sides of the hexagon may be joined with a pair of parallel sides of the square tube.

In some implementations, a composite tubular structure is formed by inserting an octagonal shaped tube into a round or square tube. In some implementations, the octagon tube is dimensioned such that all eight corners of the octagon can be joined to the interior surface of the square or round tube. In some implementations, the octagon tube is dimensioned such that two sets of parallel sides of the hexagon may be joined with the two sets of parallel sides, respectively, of the square tube. In some implementations, the octagon tube is dimensioned such that the two sets of parallel sides of the octagon tube can mate with and be joined with the depressions on the two sets of parallel sides, respectively, of the square tube.

In some implementations, a composite tubular structure is formed by inserting an inner round tube into an octagonal shaped tube and then inserting the octagonal shaped tube into an outer round tube. In some implementations, the inner round tube is dimensioned such that the inner round tube can be joined to the interior surface of the octagon at a point on all eight sides of the octagon. In some implementations, the octagon tube is dimensioned such that all eight corners of the octagon can be joined to the interior surface of the outer round tube. In some implementations, the octagonal shaped tube can be replaced with any equal sided polygon.

In some implementations, a composite tubular structure is formed by inserting an inner round tube into an accordion type tube and then inserting the accordion type tube into an outer round tube. In some implementations, the tubes are sized such that the outer surface at the peaks of the accordion tube can be joined to the interior surface of the outer round tube and the inner surface at the valleys of the accordion tube can be joined to the outer surface of the inner round tube. In some implementations, the inner tube and outer tube have grooves that mate with the peaks and valleys of the middle tube.

In some implementations, a composite tubular structure comprises an inner rectangular tube (or, in some implementations, an I-beam, a cross beam, or an eight spoke, star extrusion) inside an octagon tube inside an outer round tube. In some implementations, the inner tube (i.e., the rectangular, I-beam, cross beam, or eight spoke, star extrusion) is dimensioned such that all corners of the inner tube can be joined with the interior surface of the octagon tube. In some implementations, the rectangular tube (or I-beam, cross beam, or eight spoke, star extrusion) is dimensioned such that parallel sides of the rectangular tube (or I-beam, cross beam, or eight spoke, star extrusion) may be joined with the interior surface of parallel sides of the octagon tube, respectively. In some implementations, the octagon tube is dimensioned such that all eight corners of the octagon can be joined to the interior surface of the round tube.

In some implementations, a composite tubular structure comprises a rectangular tube having rounded corners inside a round tube having semicircular notches. In some implementations, the rectangular tube is dimensioned such that the rounded corners of the rectangular tube can mate with and be joined with the semicircular notches of the round tube. In some implementations, one pair of sides of the rectangular tube is thicker than the other pair of sides.

In some implementations, a composite tubular structure comprises an inner tube configured such that on or more surfaces (e.g., the corners, sides, or any other surface) of the inner tube can mate with and be joined with the notches on the interior sides of the outer tube. In some implementations, the inner or outer tube can be square, rectangular, circular, or any other polygon or shape.

In some implementations, a structure is formed by inserting multiple, composite tubular structures in an outer structure where the multiple, composite tubular structures are arranged to form an array. In some implementations, the outer structure is a rectangular tube and each of the multiple, composite, tubular, structures is a rectangular tube inside an octagon tube. In some implementations, the outer structure is a rectangular tube having depressions on the interior sides of the rectangular tube and each of the multiple, composite tubular structures is an octagon tube having a pair of parallel sides configured to mate with and to be joined with the depressions on the interior sides of the rectangular tube.

In some implementations, a composite tubular structure comprises two modified I-beams inserted into a round tube. In some implementations, the I-beams are dimensioned such that the top and bottom surfaces of the I-beam may be joined with the interior surface of the round tube.

Some implementations use geometry, for example thinner parallel sides as oppose to thicker perpendicular sides, to reduce bending resistance in one direction in order to increase formability in that direction.

Some implementations of the composite tubular structures employ tubes with thinner walls for reduced weight and selected geometrical structures for increased strength.

Some implementations modify the coefficient of expansion and thermal conductivity of the adhesive by the addition of filler or the utilization of a wire mesh made from the same metal. The assembly of some implementations takes advantage of the coefficient of expansion of the material by heating the outer tube and cooling the inner tube before insertion.

Some implementations are formed by a single extrusion. Where the triangles are incorporated into the extrusion mold. However, complex extrusions are much more expensive to mold and produce then simpler ones. Therefore, composite assemblies of multiple, extrusions may be less expensive and adequate for the application.

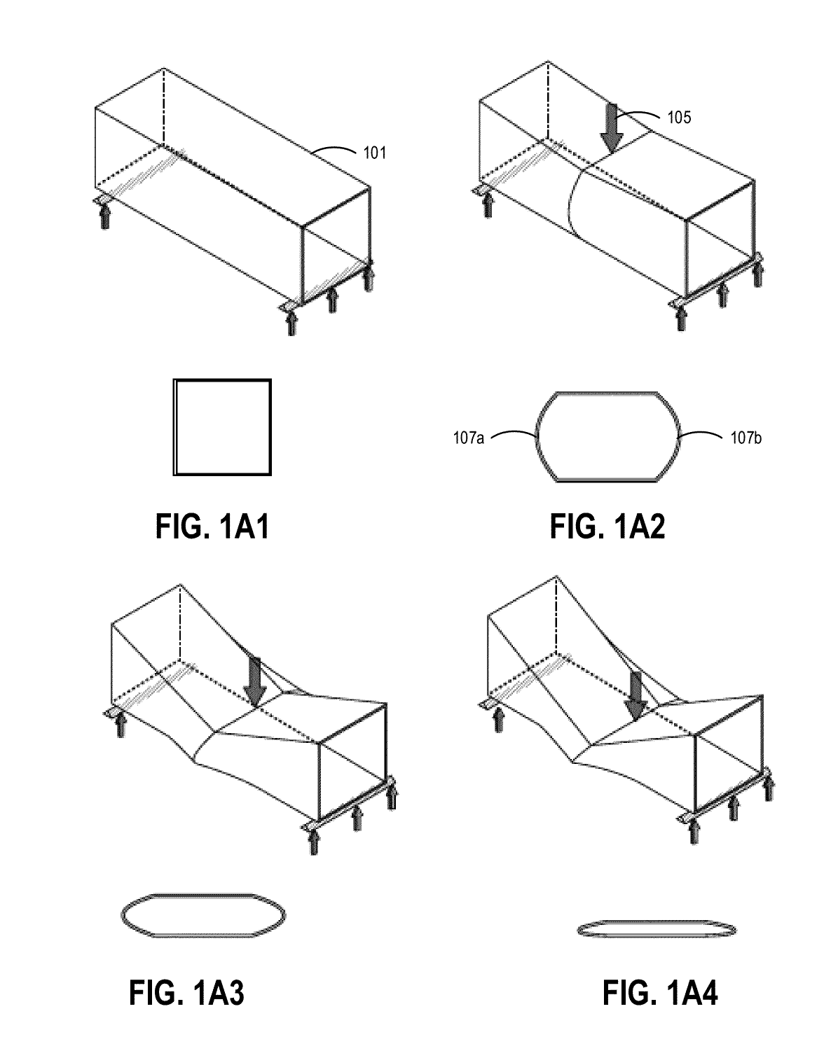

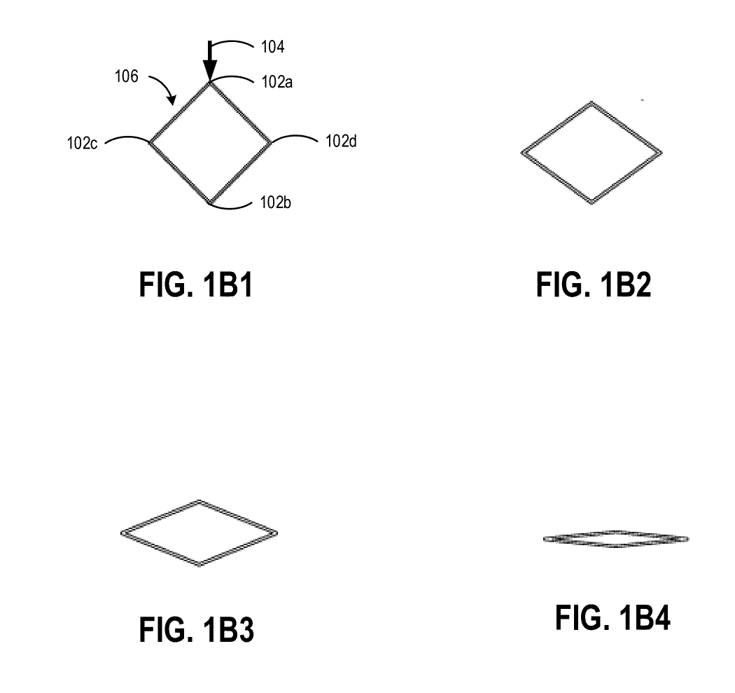

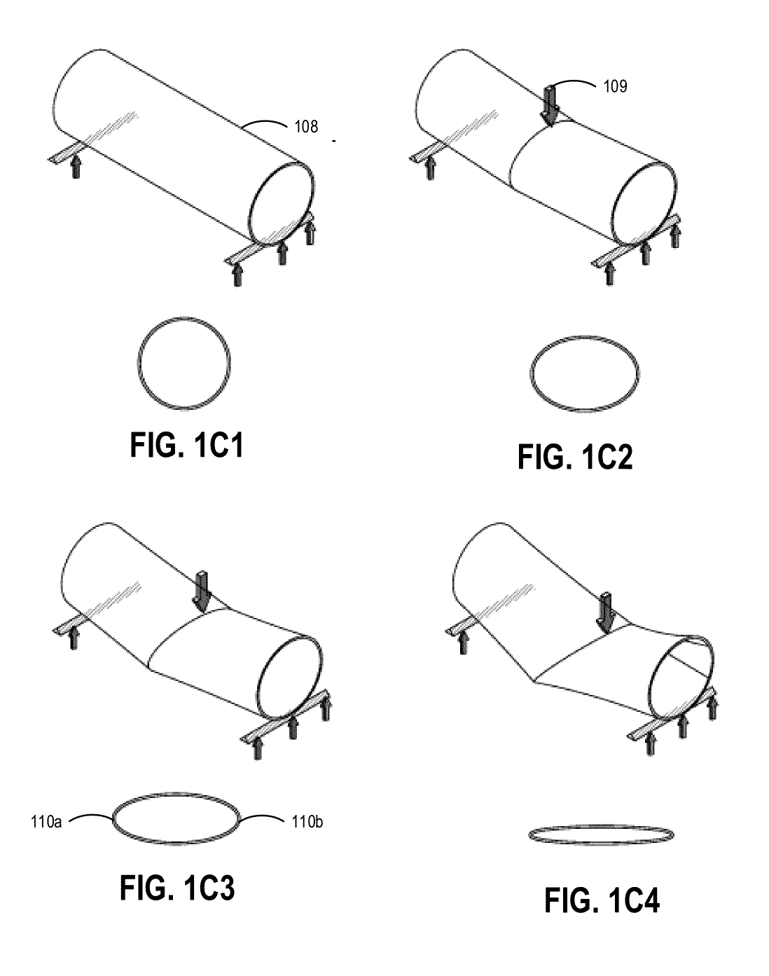

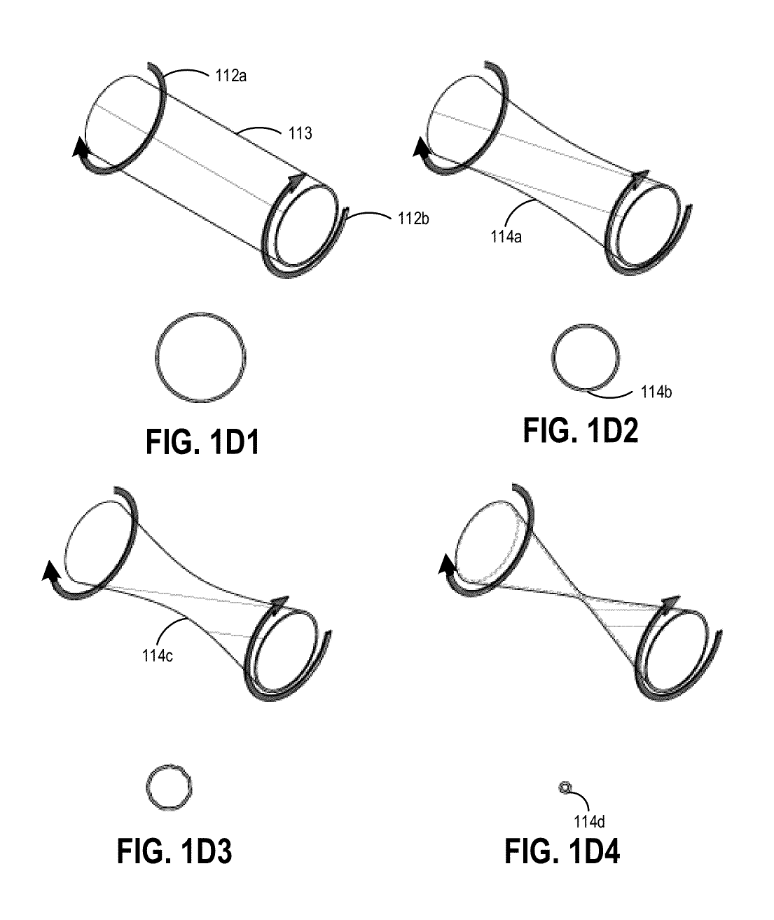

FIGS. 1A1-1D4 illustrate the impact of the geometry of a tubular structure on the axial and torsional strength of the tubular structure.

More specifically, FIGS. 1A1-1A4 illustrate the failure sequence of a rectangular tube 101 when a normal force 105 is applied to the tube 101, and FIGS. 1B1-1B4 illustrate cross-sectional views of the failure sequence of a rectangular tube 106 when a force 104 is applied diagonally.

Tube 106 of FIG. 1B1 is similar to tube 101 of FIG. 1A1 but rotated 45 degrees counter clock-wise. That is, the force 104 is applied at a point on the edge of tube 106. The failure sequence illustrated in FIGS. 1B1 to 1B4 may be a rough approximation of what initially happens when torsional (twisting) forces are applied to a rectangular tube. As shown by the cross-sectional views of the rectangular tube 106 in FIGS. 1B1-1B4, the angles at corners 102a, b increase while the angles at corners 102c, d, decrease as force 104 is applied to the tube 106. It is noted that only a relatively small force 104 may be required to bend the tube 106 because a relatively small amount of material is being deformed at the corners 102a-d.

As shown by the cross-sectional views of the rectangular tube 101 in FIGS. 1A1-1A4, more material 107a, 107b may be required to be deformed to bend tube 101 than the material required to be deformed at the corners 102a-d to bend tube 106. Thus, a greater amount of force may be required to bend tube 101 in FIGS. 1A1-1A4 than to bend tube 106 in FIGS. 1B1-1B4.

FIGS. 1C1-1C4 illustrate the failure sequence of a round tube 108 when a force 109 is applied to the tube 108. As shown by the cross-sectional views of the round tube 108 in FIGS. 1C1-1C4, less material 110a, b may be required to be deformed to bend tube 108 than the material 107a, 107b required to be deformed to bend tube 101, and more material 110a, b may be required to be deformed to bend tube 108 than the material required to be deformed at the corners 102a-d to bend tube 106. Thus, an amount of force greater than the amount of force to bend tube 106 but less than the amount of force to bend tube 101 may be required to bend tube 108.

FIGS. 1D1-1D4 illustrate the failure sequence of a round tube 113 when torsional forces 112a, b are applied to the tube 113. As shown by the cross-sectional views of the round tube 113 in FIGS. 1D1-1D4, more material 114a-d may be required to be deformed to twist tube 113 than the material required to be deformed at the corners 102a-d to bend tube 106 and the material 107a, 107b required to be deformed to bend tube 101. Thus, a greater amount of force may be required to twist tube 113 than to bend tubes 101, 106 and 108.

As demonstrated by FIGS. 1A1-1D4, the geometry of a tubular structure may affect the axial and torsional strength of the structure. For example, a rectangular tube may have greater resistance to bending and a round tube may have greater resistance to twisting.

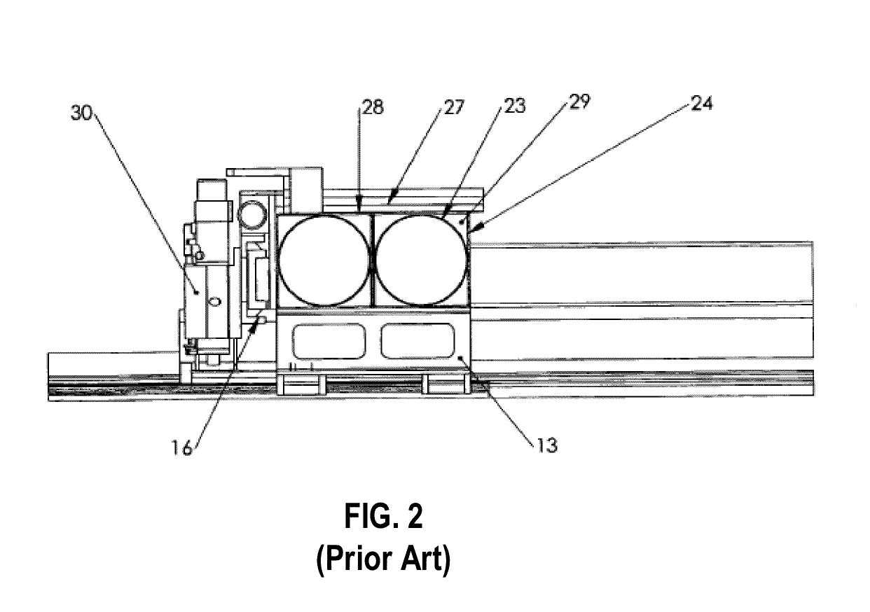

Referring to FIG. 2, U.S. Pat. No. 7,198,438 discloses a crossbeam constructed from thin-walled round steel tubing 23 inserted into square steel tubing 24 that is glued and spot-welded together. The '438 patent discloses that the round tubing has a cross-sectional configuration which has high strength against torsional forces and the square tubing has a configuration which has high strength against bending forces. According to the 438 patent, the combination of the two lightweight structural elements (i.e., the round steel tubing 23 inserted into square steel tubing 24) has very high strength against torsional forces and bending forces, providing a high strength, very stiff structural assembly. However, the structure disclosed in the '438 patent is limited to square tubes of which the side length is close to the diameter of the round tube. Furthermore, the improvement in strength of the structure disclosed in the '438 patent is limited as no triangles are formed and only two tubes are used.

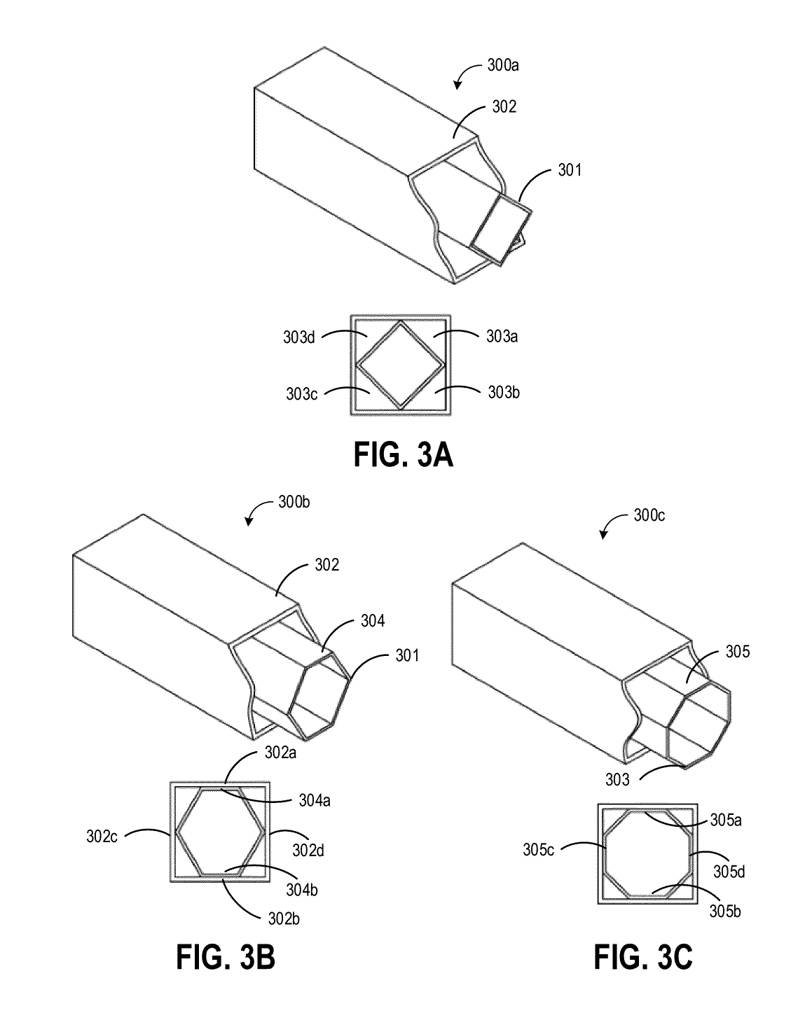

FIG. 3A illustrates an implementation of a composite tubular structure 300a of the present disclosure having a square tube 301 inserted diagonally into another square tube 302. In some implementations, the square tube 301 is dimensioned such that all four corners of the square tube 301 can be joined (e.g., by curing previously deposited adhesive or brazing or welding) to the interior surface of the square tube 302. The triangles 303a-d formed may increase the strength of the composite structure. However, the inner tube 301 may turn during bending thereby causing the corners of the inner tube 301 to lose contact with the internal sides of the outer tube 302. Some implementations of a straight composite 300a where an outer, square tube 302 and the inner square tube 301 are rigidly held during curing previously deposited adhesive, brazing or welding may be a preferred design due to strength to weight ratio improvement.

FIG. 3B illustrates an implementation of a composite tubular structure 300b that may be more resistant to the internal tube turning and losing contact with the internal sides of the outer tube. Composite tubular structure 300b includes a hexagon 304 inserted into the square tube 302. In some implementations, the hexagon tube 304 is dimensioned such that all six corners 301 of the hexagon tube 304 can be joined (e.g., by curing previously deposited adhesive or brazing or welding) to the interior surface of the square tube 302. In some implementations, the hexagon tube 304 is dimensioned such that parallel sides 304a, b of the hexagon tube 304 may be joined with the parallel sides 302a, b of the square tube 302, respectively.

FIG. 3C illustrates another implementation of a composite tubular structure 300c with more surface area between the inner and outer tubes and may produce a stronger strength to weight ratio composite tubular structure than composite tubular structure 300b. Composite tubular structure 300c includes octagon tube 305 inserted into the square tube 302. In some implementations, the octagon tube 305 is dimensioned such that all eight corners 303 of the octagon tube 305 can be joined (e.g., by curing previously deposited adhesive or brazing or welding) to the interior surface of the square tube 302. In some implementations, the octagon tube 305 is dimensioned such that two sets of parallel sides 305a, b and 305c, d of the octagon tube 305 may be joined with the two sets of parallel sides 302a, b and 302c, d, respectively, of the square tube 302.

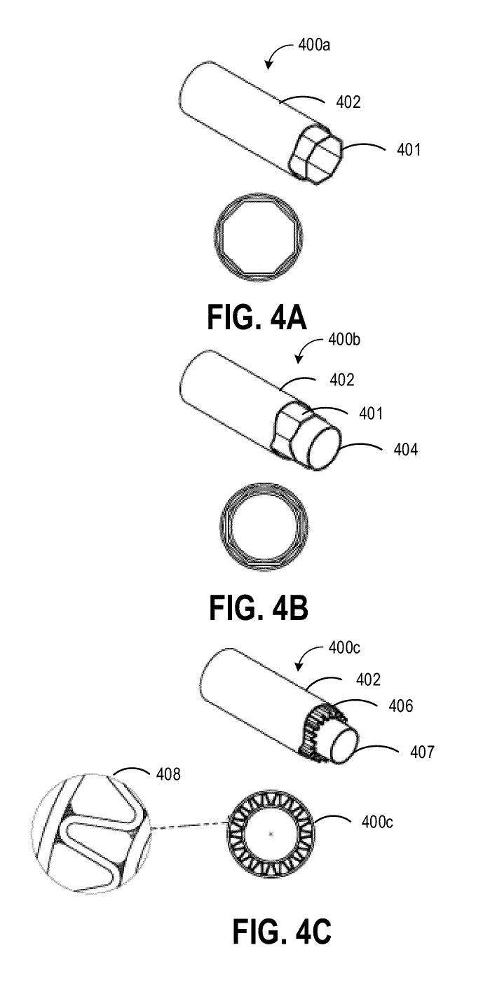

FIG. 4A illustrates another implementation of a composite tubular structure 400a of the present disclosure having an inner octagon tube 401 inserted into an outer round tube 402. In some implementations, the octagon tube 401 is dimensioned such that all eight corners of the octagon can be joined (e.g., by curing previously deposited adhesive or brazing or welding) to the interior surface of the round tube 402. The composite tubular structure 400a may have increased resistance to torsional forces.

FIG. 4B illustrates an implementation of a composite tubular structure 400b similar to composite tubular structure 400a but with the addition of a smaller round tube 404 inserted into the octagon 401. In some implementations, the round tube 404 is dimensioned such that the round tube 404 can be joined to the interior surface of the octagon at a point on all eight sides of the octagon. The composite tubular structure 400b may have a greater strength to weight ratio than the composite tubular structures discussed above. In some implementations, any equal sided polygon may be used as the inner tube 401.

FIG. 4C illustrates an implementation of a composite tubular structure 400c similar to composite tubular structure 400b but having an accordion type tube 406 inserted into the outer round tube 402. In some implementation, the surface of the accordion type tube 406 can have a sinusoidal type curve pattern 408 with peaks and valleys. The composite tubular structure 400c also can have a smaller tube 407 inserted into the accordion tube 406. In some implementations, the tubes are sized such that the outer surface at the peaks of the accordion tube 406 can be joined (e.g., by curing previously deposited adhesive or brazing or welding) to the interior surface of the round tube 402 and the inner surface at the valleys of the accordion tube 406 can be joined (e.g., by curing previously deposited adhesive or brazing or welding) to the outer surface of the round tube 407.

The strength to weight ratio of the composite tubular structure 400c may be greater than the composites discussed above due to the increased number of triangles produced by the accordion type tube 406 with the smaller tube 407 inside.

The sinusoidal type curve 408 may provide more contact area between the outer tube 402 and the accordion type polygon 406 and between the inner tube 407 and the accordion type polygon 406. As illustrated by FIG. 4C, this may produce an improved fillet using either an adhesive or high temperature, solder brazing.

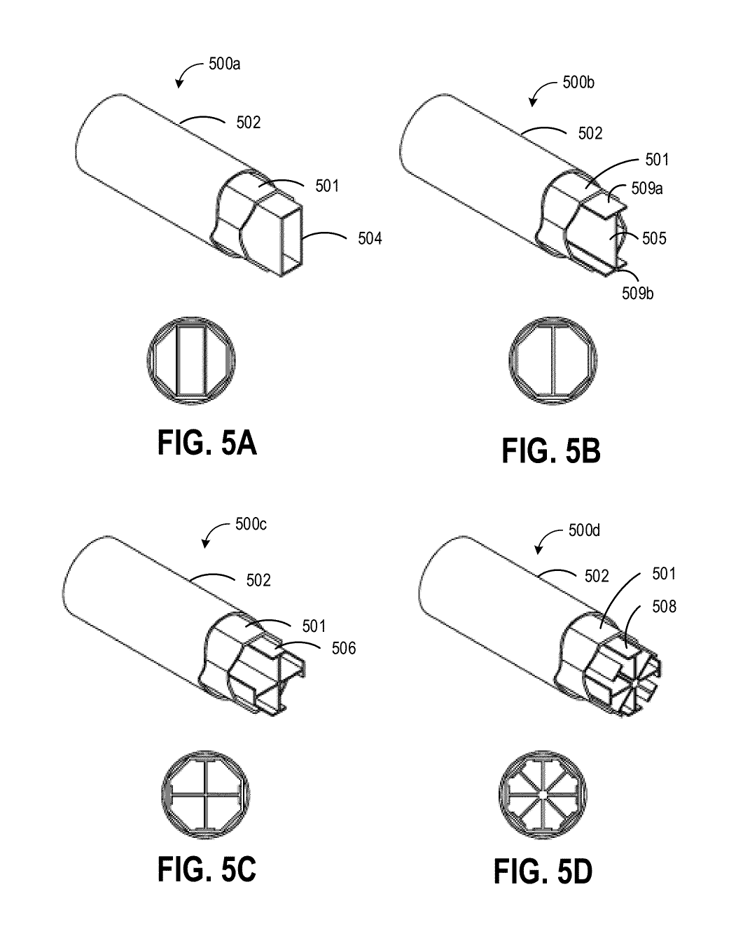

FIGS. 5A-5D illustrate, as examples, composite tubular structures that may have increased directional axial strength.

More specifically, FIG. 5A illustrates an implementation of a composite tubular structure 500a where a rectangular tube 504 is inserted into an inner octagon tube 501 that is inserted into an outer round tube 502. In some implementations, the rectangular tube 504 is dimensioned such that all four corners of the rectangular tube 504 can be joined with the interior surface of the octagon tube 501. In some implementations, the rectangular tube 504 is dimensioned such that parallel sides of the rectangular tube 504 may be joined with the interior surface of parallel sides of the octagon tube 501. In some implementations, the octagon tube 501 is dimensioned such that all eight corners of the octagon can be joined to the interior surface of the round tube 502.

FIG. 5B illustrates an implementation of a composite tubular structure 500b where an I-beam 505 is inserted into an inner octagon tube 501 that is inserted into an outer round tube 502. In some implementations, the I-beam 505 is dimensioned such that parallel sides of the I-beam 505 may be joined with the interior surface of parallel sides of the octagon tube 501 and the octagon tube 501 is dimensioned such that all eight corners of the octagon can be joined to the interior surface of the round tube 502.

FIG. 5C illustrates an implementation of a composite tubular structure 500c where a cross beam 506 is inserted into an inner octagon tube 501 that is inserted into an outer round tube 502. In some implementations, the cross beam 506 is dimensioned such that the two sets of parallel sides of the cross beam 506 may be joined with the interior surface of two sets of parallel sides of the octagon tube 501, respectively, and the octagon tube 501 is dimensioned such that all eight corners of the octagon can be joined to the interior surface of the round tube 502.

FIG. 5D illustrates an implementation of a composite tubular structure 500d where an eight spoke, star extrusion 508 is inserted into an inner octagon tube 501 that is inserted into an outer round tube 502. In some implementations, the eight spoke, star extrusion 508 is dimensioned such that the four sets of parallel sides of the eight spoke, star extrusion 508 may be joined with the interior surface of four sets of parallel sides of the octagon tube 501, respectively, and the octagon tube 501 is dimensioned such that all eight corners of the octagon can be joined to the interior surface of the round tube 502.

Composite tubular structure 500d may have multidirectional axial strength from insertion of the eight spoke, star extrusion 508.

The contact ends (e.g., 509a, b of FIG. 5B) of the inserted extrusions 504, 505, 506 and 508 are designed to create greater contact area for the adhesive or brazed bond between one or more interior side surfaces of the octagon 501 and the inserted extrusion.

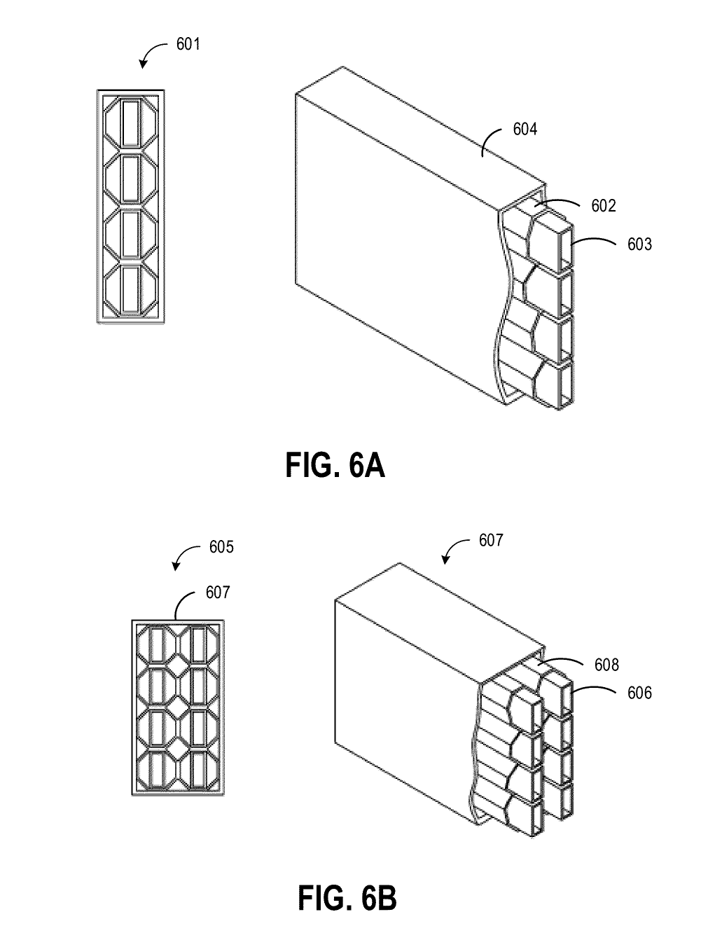

FIGS. 6A-B illustrate, as examples, rectangular, composite tubular structures that may have increased axial strength per unit weight.

FIG. 6A illustrates an implementation of a rectangular, composite tubular structure 601 having four internal octagon tubes 602 inside a rectangular tube 604 where a smaller rectangular tube 603 is inserted into each octagon tubes 602. As shown in FIG. 6A, the octagonal tubes 602 are inserted length-wise into the rectangular tube 604 one on top of the other where the octagonal tubes 602 are dimensioned such that two sides of each of the octagonal tubes 602 are in contact with the inner surface of the rectangular tube 604 and one side of each of the octagonal tubes 602 are in contact with another octagonal tube to form a 1 by 4 array inside the rectangular tube 604. The dimensions of an array, as the term is used throughout the present disclosures, correspond to the X-axis (row) by the Y-axis (column) (e.g., 1 by 4). In some implementations, each of the rectangular tubes 603 is dimensioned such that parallel sides of the rectangular tube 603 may be joined with the interior surface of parallel sides of the respective octagon tube 602.

FIG. 6B illustrates another implementation of a rectangular, composite tubular structure 605 having eight internal octagonal tubes 608 inside a rectangular tube 607 where a smaller rectangular tube 606 is inserted into each octagon tube 608.

As shown in FIG. 6B, the octagon tubes 608 are inserted length-wise and width-wise into the rectangular tube 607 to form a 2 by 4 array inside the rectangular tube 607 where for each column of octagon tubes 608 one side of each of the octagonal tubes 608 are in contact with an inner surface of the rectangular tube 607 and one side of each of the octagonal tubes 608 are in contact with another octagonal tube of the other column. In some implementations, each of the rectangular tube 606 is dimensioned such that parallel sides of the rectangular tube 606 may be joined with the interior surface of parallel sides of the respective octagon tube 608.

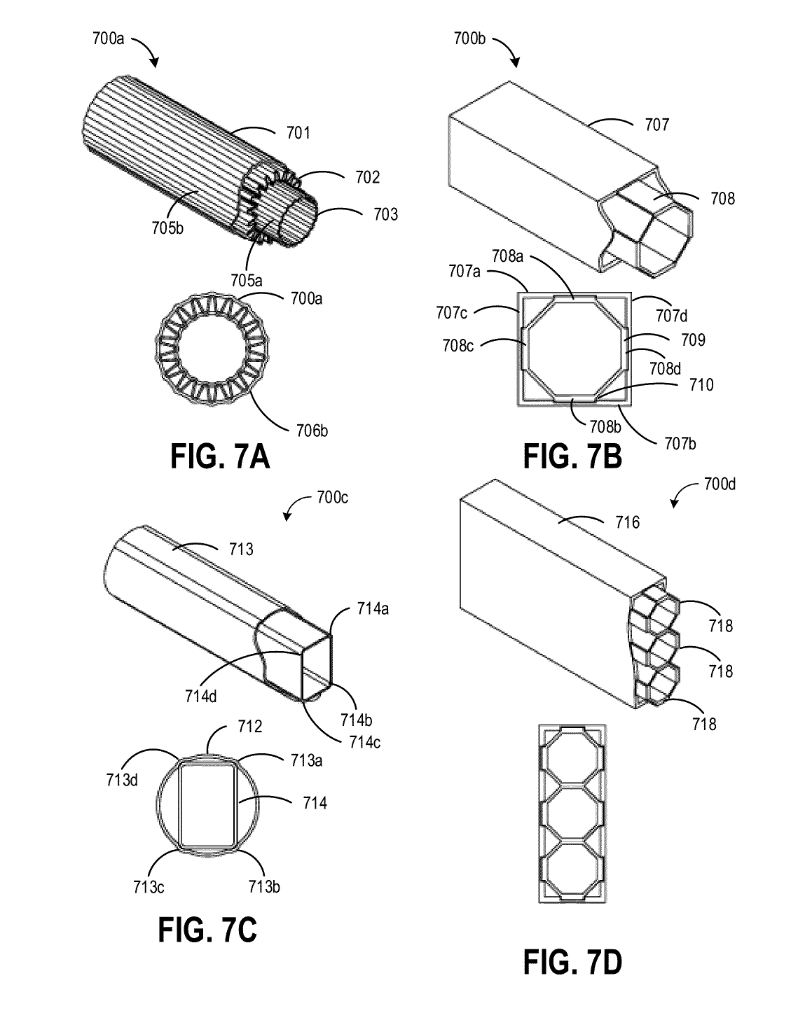

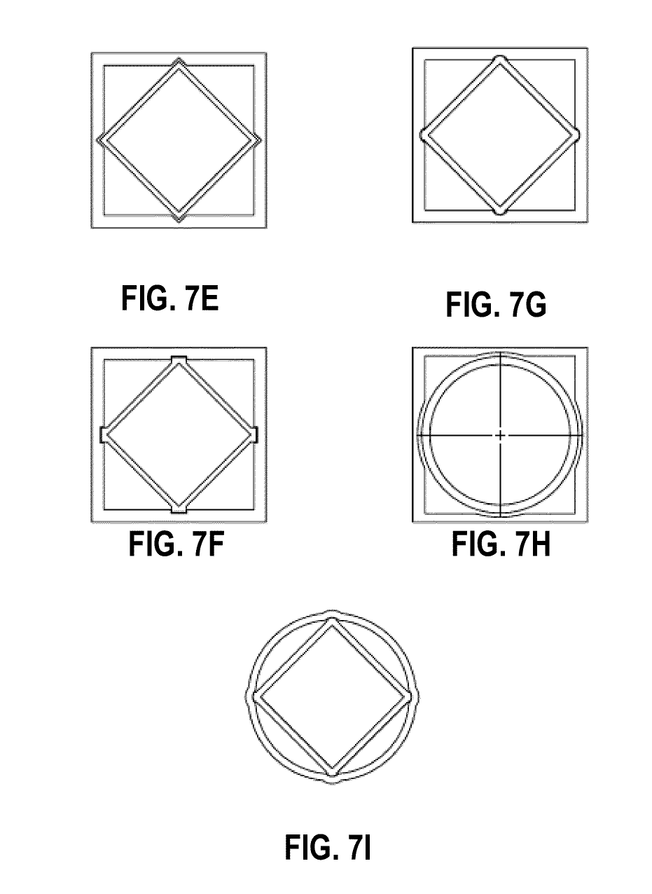

FIG. 7A illustrates another implementation of a composite tubular structure 700a where an inner round tube 703 is inserted into a middle accordion type tube 702 that is inserted into an outer round tube 701. In some implementation, the surface of the accordion type tube 702 can have a sinusoidal type curve pattern with peaks and valleys. As shown in FIG. 7A, the inner tube 703 and outer tube 701 have grooves 705a, b, respectively, that mate with the peaks and valleys of the middle tube 702. In other words, the grooves of the inner tube 703 and outer tube 701 serve as a lock and the peaks and valleys of the middle tube serve as a key. In some implementations, the tubes are sized such that the outer surface at the peaks of the accordion tube 702 can mate and be joined with (e.g., by curing previously deposited adhesive or brazing or welding) the interior surface at the grooves of the round tube 701 and the inner surface at the valleys of the accordion tube 702 can be mated and joined (e.g., by curing previously deposited adhesive or brazing or welding) to the outer surface at the grooves of the round tube 703. Due to the mechanical interferences caused by the grooves of the inner tube and outer tube and the peaks and valleys of the middle tube, composite 700a may have greater resistance to failure of the adhesive or brazed bond.

FIG. 7B illustrates another implementation of a composite tubular structure 700b where an inner octagon tube 708 is inserted into a square tube 707. In some implementations, the octagon tube 708 is dimensioned such that the two sets of parallel sides 708a, b and 708c, d of the octagon tube 708 can mate with and be joined with the depressions 710 on the two sets of parallel sides 707a, b and 707c, d, respectively, of the square tube 707. In other words, the depressions 710 of the square tube 707 serve as a lock and the two sets of parallel sides 708a, b and 708c, d of the octagon tube 708 serve as a key. In this way, the adhesion of any adhesive may be increased by mechanical means.

FIG. 7C illustrates another implementation of a composite tubular structure 700c where a rectangular tube 714 having rounded corners 714a, b, c, d is inserted into a round tube 713 having semicircular notches 713a, b, c, d. In some implementations, the rectangular tube 714 is dimensioned such that the rounded corners 714a, b, c, d of the rectangular tube 714 can mate with and be joined with the semicircular notches 713a, b, c, d, respectively, of the round tube 713.

FIG. 7D illustrates another implementation of a composite tubular structure 700d having three internal octagon tubes 718 inside a rectangular tube 716. As shown in FIG. 7D, the octagonal tubes 718 are inserted length-wise into the rectangular tube 716 one on top of the other to form a 1 by 3 array inside the rectangular tube 716. In some implementations, each of the octagon tubes 718 is dimensioned such that a pair of parallel sides can mate with and be joined with the depressions on the interior sides of the rectangular tube 716.

FIGS. 7E to 7I illustrate other implementations of composite tubular structures having inner tubes configured such that the corners or other surfaces of the inner tube can mate with and be joined with the notches on the interior sides of the outer tube. In some implementations, the interior or outer tube can be square, rectangular, or a circle and the outer tube can be square.

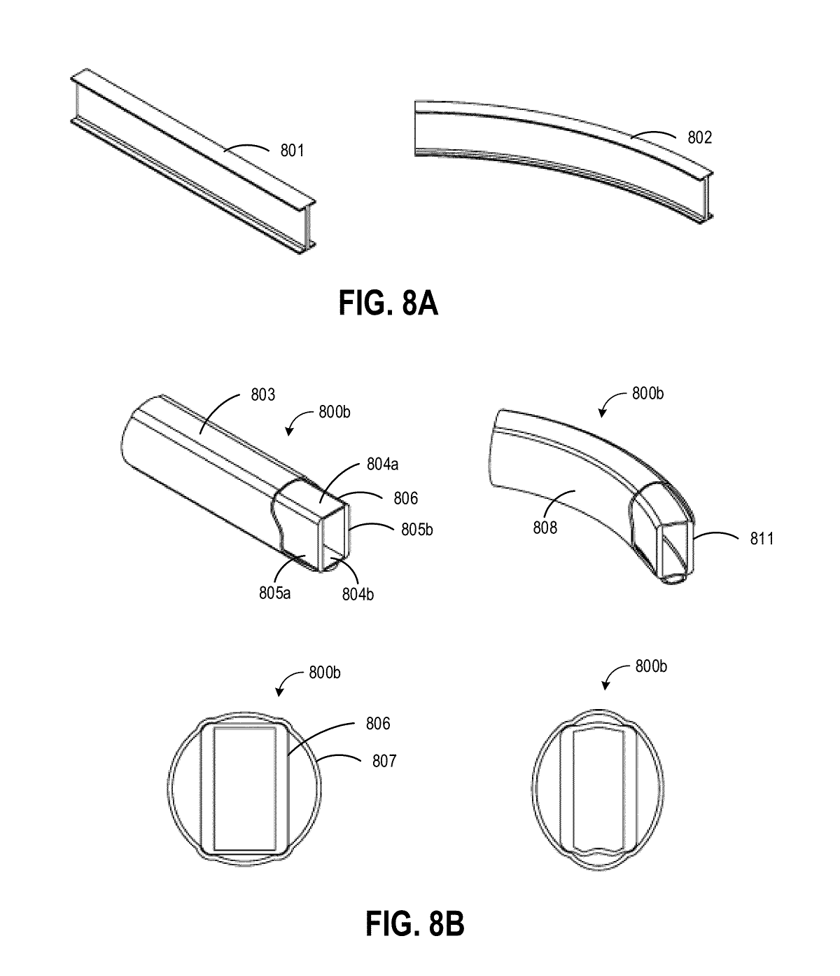

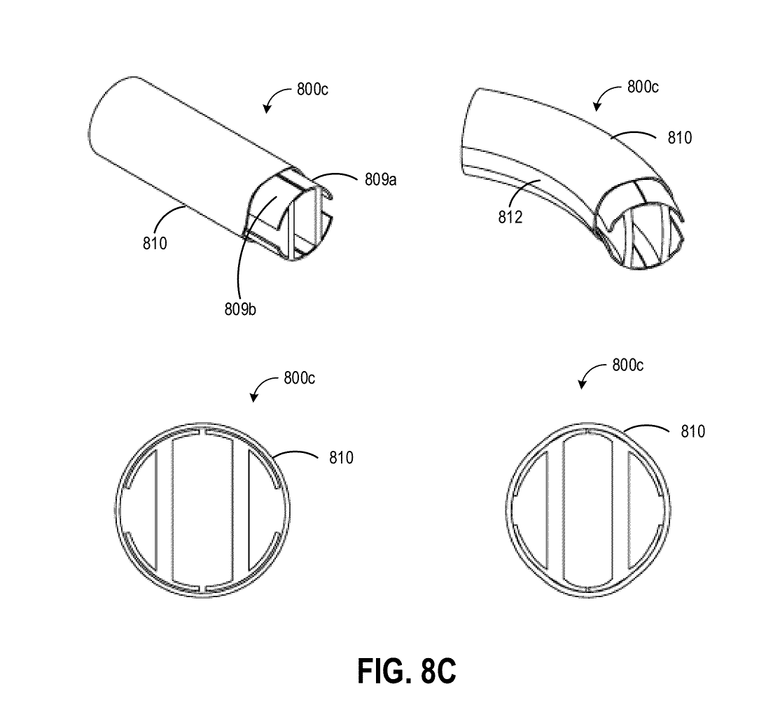

As shown in FIGS. 6A and 6B, geometry, along with the tubular composite design, can be used to strengthen a composite tube in one dimension as needed for reliable performance. Geometry also can be used to weaken a composite in the perpendicular dimension to improve formability of the composite prior to curing the adhesive or completing the brazing operation. As shown in FIG. 8A, a metal strip 801 can be readily bent to form arc 802. The perpendicular strength of I beam 801 may remain the same.

FIG. 8B illustrates an implementation of a rectangular, composite tubular structure 800b similar to the rectangular, composite tubular structure 700c of FIG. 7C but with the top and bottom sides 804a, b thinner than sides 805a,b of the inner tube 806. In this way, the outer tube 807 can be bent more easily to produce radius 808. The thick vertical sides 805a&b remain in position and, after the adhesive is cured, will form a rectangular tube to provide the vertical axial strength required by design specification.

FIG. 8C illustrates an implementation of a composite tubular structure 800c where two modified I-beams 809a, b are inserted into a round tube 810. In some implementations, the I-beams are dimensioned such that the top and bottom surfaces of the I-beams 809a, b may be joined with the interior surface of the round tube 810. This composite may be more readily bent to produce radius 812 than the same round composite containing a rectangular tube. Once bent, heat curing or brazing produces a rigid composite that may have the same axial strength as a composite with a rectangular inner tube.

There are many other composite implementations that will provide formability ease and increased axial strength. The composite implementation 500b in FIG. 5B as compared to 500a in FIG. 5A is another example.

The relative thermal coefficients of expansion and heat conductivity of the adhesive relative to the metal can also determine the long term reliability of the composite. Typically, the adhesive will have a higher thermal coefficient of expansion and lower thermal conductivity as compared to the metal. In the bright sunshine of the morning, the outer tube will heat first and expand relative to the inner tube. This places the adhesive in tension and may initiate a crack at the edge of the adhesive fillet, which will grow each day with the thermal heating cycle. During the cooling cycle, the higher coefficient of expansion of the adhesive puts the bond in tension.

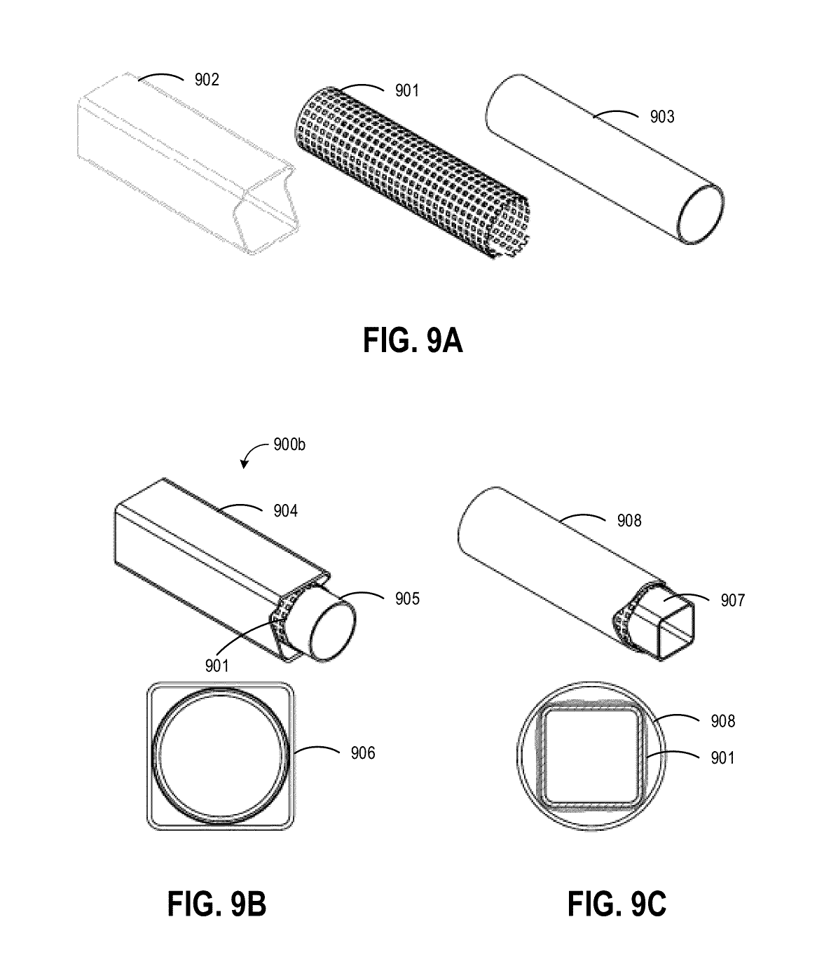

FIG. 9A shows the components that can be used to form various composites. These components include a rectangular tube 902, a round tube 903, and a wire mesh 901. The wire mesh 901 may be made from the same metal as the tubes 902 and 903 and impregnated with adhesive to modify the total coefficient of expansion and thermal conductivity of the resulting bond. Increasing the thermal conductivity between the outer and inner tubes makes the temperature of the composite more uniform and reduces the thermal induced forces. Adjusting the adhesive to a thermal coefficient of expansion closer to that of the metal tubes also reduces thermal induced forces.

FIG. 9B illustrates an implementation of a rectangular, composite tubular structure 900b formed from the components of FIG. 9A. The composite tubular structure 900b includes a round tube 905 incased in wire mesh/adhesive 901 that is inserted into a square tube 906. FIG. 9C illustrates a square tube 907 incased in a wire mesh/adhesive 901 and inserted into round tube 908. Dimensions of tube 905 must be controlled so that the gap between tube 905 and tube 904 closely matches the thickness of the wire mesh/adhesive 901. The diagonal dimensions of tube 907 must be controlled so that the gap between the corners of tube 907 and the inner surface of tube 908 is close to the thickness of wire mesh/adhesive 901.

Other implementations exploit various fillers of the adhesive such as fine particles of metal, calcium carbonate, aluminum oxide, etc. to lower the coefficient of expansion and/ or to increase the thermal conductivity of the adhesive. These fillers can thus improve long term reliability of the composite. In other implementations, various fiber materials (glass, carbon, etc.) may replace the metal of the wire mesh 901 to form prepreg layers of various types. The fiber materials provide the function of the fillers and facilitate the assembly operation in that the adhesive is applied by wrapping the prepreg around the inner tube.

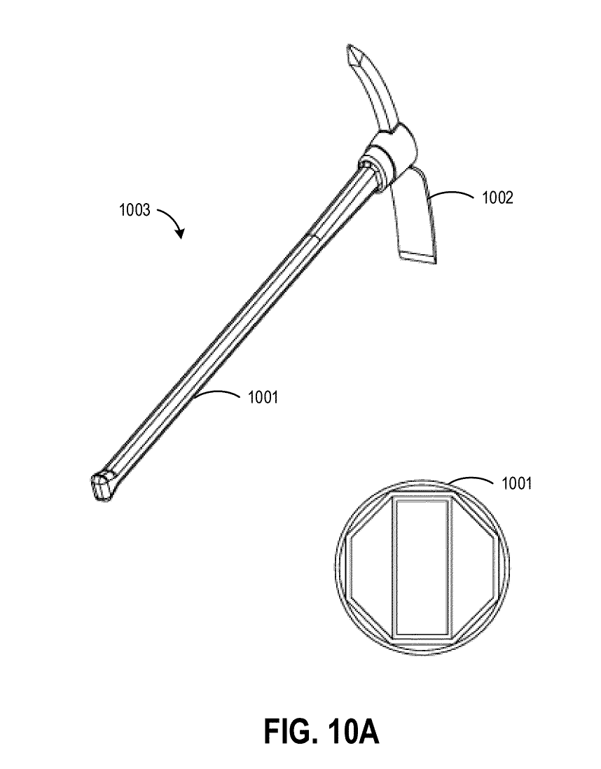

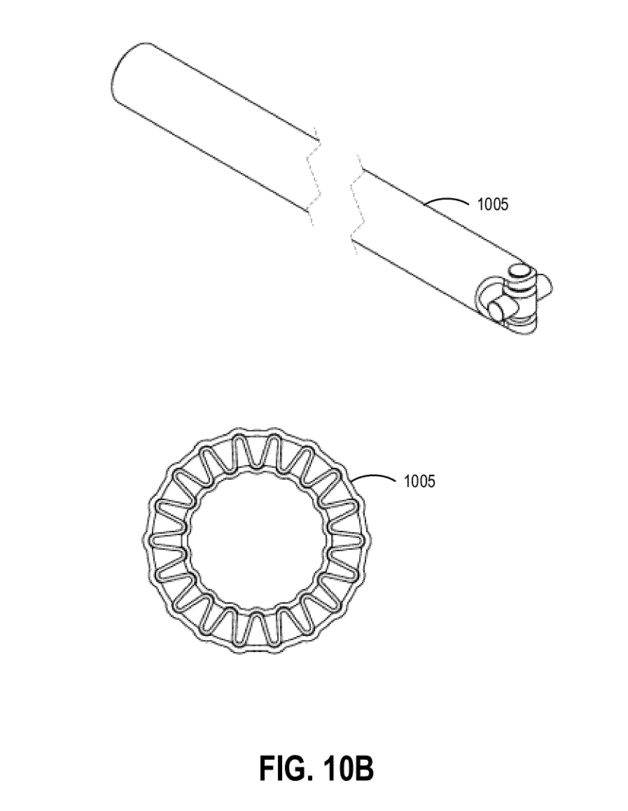

FIGS. 10A and B illustrate two applications where composite tubular structures can improve the performance of the end item.

As shown in FIG. 10A, a composite tubular structure disclosed herein can be implemented in handles for hand tools (e.g., hammers, lawn and garden tools such as hoes, cultivators, mattocks, planters, etc. and certain specialty hand tools). FIG. 10A illustrates a mattock 1003 including a handle 1001 having the composite tubular structure 500a of FIG. 5A.

The weight in many hand tools needs to be concentrated in the head and not in the handle and the handle needs to have good torsional strength and axial strength in one direction as illustrated by composite 500a.

FIG. 10B illustrates a drive shaft 1005 having the same structure as the composite tubular structure 700a shown in FIG. 7A

Material alloy, material thickness, type of bond and material, and number of triangles may be adjusted to meet the strength to weight ratio specified for the application.

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A composite tubular structure comprising:
an inner tube inside an outer tube, wherein the outer tube includes notches on one or more interior sides of the outer tube and wherein the inner tube is configured such that on or more surfaces of the inner tube can mate with and be joined with the notches on the interior sides of the outer tube.

2. The composite tubular structure of claim 1 wherein the inner tube is a square and the outer tube is a square.

3. The composite tubular structure of claim 1 wherein the inner tube is octagonal and the outer tube is a square.

4. The composite tubular structure of claim 1 wherein the inner tube is rectangular and the outer tube is circular.

5. The composite tubular structure of claim 4 wherein one pair of sides of the rectangular tube is thicker than the other pair of sides.

6. The composite tubular structure of claim 1 wherein the inner tube is circular and the outer tube is rectangular.

7. A composite tubular structure comprising:
a bonding material;
a separate equal sided polygon inner tube disposed inside a separate round or square outer tube;
wherein the polygon tube is dimensioned such that all corners of the polygon tube can be joined with the bonding material to an interior surface of the round or square outer tube; and
wherein there is a physical contact between at least a portion of an outer surface of the inner tube, the bonding material, and at least a portion of the interior surface of the outer tube, thereby configured to provide the composite tubular structure with an increased resistance to twists and bends.

8. The composite tubular structure of claim 7 wherein the equal sided polygon tube is an octagonal shaped tube and wherein the octagon tube is dimensioned such that all eight corners of the octagonal shaped tube can be joined to an interior surface of the round or square tube.

9. The composite tubular structure of claim 7 wherein the outer tube is square and includes a depression on the interior surface of its sides and the octagonal shaped tube is dimensioned such that the two sets of parallel sides of the octagon tube can mate with and be joined with the depressions on the respective two sets of parallel sides of the square tube.

10. The composite tubular structure of claim 7 further comprising an inner round tube inside octagonal shaped tube wherein the outer tube is round and wherein the inner round tube is dimensioned such that the inner round tube can be joined to the interior surface of the octagonal shaped tube at a point on all eight sides of the octagon and wherein the octagonal shaped tube is dimensioned such that all eight corners of the octagon can be joined to an interior surface of the outer round tube.

11. A composite tubular structure comprising:
an inner round tube inside an accordion type tube inside an outer round tube wherein the tubes are sized such that the outer surface at the peaks of the accordion tube can be joined to the interior surface of the outer round tube and the inner surface at the valleys of the accordion tube can be joined to the outer surface of the inner round tube.

12. The composite tubular structure of claim 10 the inner round tube and outer round tube have grooves that mate with the peaks and valleys of the accordion type tube.

13. A composite tubular structure comprising:
an inner rectangular tube or I-beam, a cross beam, or eight spoke, star extrusion inside an octagon tube inside an outer round tube wherein the inner tube is dimensioned such that all corners of the inner tube can be joined with an interior surface of the octagon tube and wherein the octagon tube is dimensioned such that all eight corners of the octagon can be joined to an interior surface of the outer round tube.

14. The composite tubular structure of claim 12 wherein the inner tube is dimensioned such that parallel sides of the inner tube may be joined with an interior surface of parallel sides of the octagon tube, respectively.

15. A composite tubular structure comprising:
a plurality of composite tubular structures wherein each of the composite tubular structures is a rectangular tube inside an octagon tube wherein the plurality of composite tubular structures are arranged to form an array inside a rectangular tube.

16. The composite tubular structure of claim 12 wherein the rectangular tube includes depressions on the interior sides of the rectangular tube and wherein the octagon tube includes a pair of parallel sides configured to mate with and joined with the depressions on the interior sides of the rectangular tube.

17. A composite tubular structure comprising:
two modified I-beams inside a round tube wherein the I-beams are dimensioned such that the top and bottom surfaces of the I-beam may be joined with the interior surface of the round tube.

18. A composite tubular structure comprising:
an inner tube,
an outer tube, and
a wire mesh made of the same metal as the inner tube and outer tube wherein the wire mesh is impregnated with an adhesive and wherein the inner tube is configured such that on or more surfaces of the inner tube can be joined with the an interior surface of the outer tube using the wire mesh.
